(19) United States
(12) Patent Application Publication
(10) Pub. No.: US 2005/0193743 A1
(43) Pub. Date: Sep. 8, 2005

(54) High-pressure cryogenic gas for treatment processes

(76) Inventors: John Foss, Naperville, IL (US); Robert T. Oesterreich, Sugar Land, TX (US)

Correspondence Address: THE MATTHEWS FIRM, 2000 BERING DRIVE, SUITE 700, HOUSTON, TX, 77057, US

(21) Appl. No.: 10/794,113

(22) Filed: Mar. 5, 2004

(51) Int. Cl. F17C 9/02; F25J 3/00

(52) U.S. Cl. 62/50.2

(57) ABSTRACT

The present invention relates to cryogenic processes and systems for making and using high-pressure gas to quench or rapidly cool metals or other heated materials. The gas is preferably produced without pumps, compressors, and large high-pressure bulk storage tanks. The apparatus producing such gas comprises a cryogenic bulk storage tank, a pressure building apparatus, and a high-pressure vaporizer. A dew point monitor can be used to check gas purity to ensure uniform quenching and to prevent damage to the treated parts by, for example, water vapor. The method and system also may include a system that monitors the temperature, pressure, and level of liquid cryogen in the bulk storage tank and automatically calls in a refill for the storage tank.

### BACKGROUND

There are a variety of processes for treating metals, metal alloys, and other compositions of parts, components, and pieces. For example, heat treatment and carburization, or the introduction of carbon into the surface of metal and metal alloy pieces to improve their hardness, are examples of such procedures known in the art.

U.S. Pat. No. 5,702,540 to Kubota, for example, discloses a vacuum carburizing method for steel, a carburized steel product, and a vacuum carburizing device where gaseous unsaturated aliphatic hydrocarbons such as acetylene are used in a heating chamber with a vacuum of not more than 1 kPa (0.01 bars).

There are many other different ways to heat treat as well as carburize metal or metal alloy pieces. Once the metals are carburized or otherwise heat treated, it is common to quench the still heated parts to cool and/or further alter the characteristics of the metals or other materials that have been heat treated.

For example, U.S. Pat. No. 6,451,137, to Pelissier, teaches a method of quenching after a low-pressure carburization, i.e., under a vacuum or under a gas pressure lower than atmospheric pressure. Therein, the carbonitrided parts are then quenched by submitting the parts to an atmospheric air flow at high pressure, greater than 5 bars.

The invention herein is directed to producing high pressure gases at high rates of flow, preferably without the use of compressors and pumps, and is especially useful in quenching apparatus and applications where large volumes of high pressure quench gas is necessary.

The present invention can also be used after carbonitriding, where ammonia is generally added to the enrichment gas used during carburization. The result is the forming of nitrides at the part surface, instead of carbides for the carburization, which is a well-known result.

The carburizing process consists of submitting the parts to be processed such as metal pieces and parts such as tools, steels, gears, and the like, hereinafter referred to as “metal pieces” in a chamber which is preferably airtight, heating the chamber to about 1000° C., and injecting a carbon containing compound such as propane and/or acetylene in liquid and/or gas form into the chamber. At that temperature, and under a vacuum, the propane or acetylene dissociates and the carbon molecules therefrom deposit on the surface of the metal being treated. As the procedure continues, the carbon molecules saturate the surface of the parts with the carbon from the decomposition. The parts continue to accumulate carbon surface deposits for a certain cycle or time. It may also be also preferable to incorporate a fan for circulating the furnace atmosphere to prevent stratification of the carbon, which can lead to uneven deposits and/or the need for higher than necessary carbon levels. When this is done for an adequate period or a predetermined time and/or when the deposit layer/carburization is adequate, a diffusion cycle is run. During the diffusion cycle, nitrogen is injected into a chamber, which can be separate or part of the heating chamber. The respective durations of the heat treatment and/or carburization or enrichment and diffusion steps as well as their number depend on the desired carbon concentration and desired carburizing depth in the part; these processes are well known in the art.

Once there is a sufficient carbon layer, which is associated with hardness, the parts that are typically in baskets, platforms, or other holding apparatuses are moved to a chamber for quenching which may be separate or a part of the heat-treating furnace. The quenching must be rapid enough to cool down the parts and not damage their surface, and to yield a smooth, uniform surface state, while preferably maintaining the general color of the metal such as steel (i.e., gray). In the prior art methods, the metal pieces are typically moved out of the furnace and taken elsewhere for quenching in oil. Thereafter, the parts and components would come out oily, and they would have to be cleaned. As an alternative, the oils and the usual liquid quenchants are replaced with high quench gas in the quench chamber. The high pressure gas is introduced/sprayed/injected into the chamber through the nozzles or other spraying, controlling, or targeting apparatuses to contact and cool, at least partially, the heat treated parts. Because one of the purposes of quenching is to obtain a fast cooling of the carburized parts, it is also generally desirable to obtain the fastest possible cooling rate. By elevating the gas pressure above the pressures at which these gases are normally stored at and by quenching above the pressures at which these gases are normally stored, quenching rates can be greatly increased, speeding the cooling and in some instances using less gas. Further, high-pressure quench gas in the chamber cleans the unwanted deposits on the carburized metals, better than the liquid quenchants, and also eliminates the cleansing or cleaning step. Additionally, the quenching process must not alter the carburized or treated surface or the surface hardness of the carburized part. In fact, the gases perform at least as well as their liquid counterparts, whose handling and disposal has become an issue both environmentally and on a cost basis. Therefore, quenching by gas is often preferred since dry and clean parts can be obtained.

A typical method for achieving the gas pressures required for gas quenching processes is to compress the quench gas after the liquid cryogen is vaporized by a mechanical gas compressor. The compressed gas is then typically stored in a high-pressure buffer tank. These compressor systems are about U.S. $150,000 to $175,000 dollars. In these prior art applications, the high pressure quenching gas is typically fed from the high-pressure buffer tank to the quenching chamber.

The source of nitrogen fed to a compressor can be a liquid nitrogen truck with a pump that is put in proximity of the compressor, or the liquid nitrogen may be delivered out of the truck by a high-pressure pump, into a high pressure storage tank that would get up to 30 bars and then go into a high pressure vaporizer to a buffer tank that is fed into the quenching vessel. However, there are many disadvantages, including the expense of having a high pressure tank, plus the moving parts associated with the pumps, which must be maintained and replaced, and may malfunction at inopportune times.

Another method of obtaining high-pressure quench gas is to elevate the pressure of the liquid cryogen using high-pressure liquid cryogenic pumps and high-pressure vaporizers. One way to accomplish this method is to use a standard liquid nitrogen storage tank, which for example typically stores about 1,500 to about 11,000 gallons of gas at up to about 17 bars of pressure, in conjunction with a high-pressure pump that is in line with a high pressure vaporizer.

All of the previously described methods used to achieve the elevated pressures require pumps, or mechanical or rotating equipment that is expensive, space consuming, and is subject to failure. These methods also require nonstandard storage tanks, vaporizers, and design conditions. The additional equipment and more stringent design conditions present opportunities for equipment failure and increased capital costs that seriously impact the economics of this process.

Further, there are still some cooling rates that cannot be achieved without the nitrogen or other gases or gas mixtures being at higher pressures, where it is desirable to bring the gas to a pressure of about 20-30 bars (about 290 psig to about 435 psig) which is then fed or injected into a chamber for quenching. In standard bulk storage nitrogen tanks with a vaporizer system, the maximum working pressure that can be obtained is about 17 bars (250 psig). The significance of the pressure difference is that the desired cooling rates cannot be obtained until the pressure is raised.

Several ways of raising the pressure of liquid cryogen are known. A method of creating the desired pressure of the liquid cryogen is to pressurize the tank within which the bulk supply of cryogenic liquid is stored. Such a system is available from MVE, Inc. of New Prague, Minn., and utilizes a bulk cryogenic storage tank. The pressure within the storage tank is increased by gravity feeding cryogenic liquid to a heat exchanger that heats and converts the liquid to vapor/gas. The vapor created thereby is returned to the storage tank, and increases the pressure within the tank. Pressurized cryogenic liquid from the bulk tank is then delivered to the particular application at the desired transfer pressure, or, the liquid can be vaporized in another heat exchanger if gas is required. While this type of system works well, cryogenic bulk storage tanks that are able to withstand pressures in the 400 psig range are expensive when compared to their lower pressure counterparts.

Instead, it is preferable in many instances for a system to utilize a low pressure bulk storage tank to store a bulk quantity of cryogenic liquid with the liquid therefrom being directed to a smaller transfer tank or use tank that may be pressurized. Such transfer and use tanks may be pressurized in several ways. One way is to heat a portion of the fluid in the tank directly with an electric heater. While this will increase the pressure within the tank, it will also warm the cryogenic liquid therein to a saturated state. As a result, if the system sits unused for a period of time, heat leakage into the tank will eventually cause a portion of the saturated cryogenic liquid to boil off. This will potentially increase the pressure in the tank to a level above the tank safety valve setting causing a portion of the cryogenic vapor to be vented to the atmosphere. This is undesirable. Another way of pressurizing a tank of cryogenic liquid is to feed the cryogenic liquid from the tank to a pressure building heat exchanger that heats the liquid. The produced vapor is then returned to the vapor space above the cryogenic liquid to pressurize the tank.

U.S. Pat. No. 4,947,651 to Nesser et al. discloses a pressure building circuit for a double walled tank that contains a low temperature fluid, using a pressure building coil. The coil vaporizes the cryogenic liquid and the gas is supplied to the top of the tank to maintain head pressure. That patent is fully incorporated by reference herein, and the cryogenic liquid that is to be vaporized and used for quenching may be pressurized by this method.

U.S. Pat. No. 5,937,655 to Weiler et al. discloses a device for pressurizing a tank containing a supply of cryogenic liquid that has a tubular enclosure disposed within the cryogenic liquid. The device can fits through the tops of existing cryogenic tanks. An electric heater element that vaporizes a portion of the cryogenic liquid is disposed in the bottom of the tubular enclosure. The apparatus pressurizes a tank containing cryogenic liquid by allowing a portion of the cryogenic liquid to enter a tubular enclosure, heating the portion of cryogenic liquid within the tubular enclosure to create a flow of vapor and liquid cryogen and directing the flow of vapor and liquid cryogen to the head space and/or a pressure builder coil. An insulating tube may optionally be disposed about the tubular enclosure. In addition, a ball may optionally be positioned adjacent the opening in the tubular enclosure so that a check valve is formed. The tubular enclosure may also have an opening in its bottom that is in communication with a pressure builder coil that is external to the tank. The pressure building coil also vaporizes cryogenic liquid that is conveyed through the tubular enclosure. The vapor side of the pressure builder coil is in communication with the head space of the tank and feeds the vaporized gas to the head space of the tank. As the mixture of cryogenic liquid and gas reach the pressure builder coil, the remaining liquid is converted to gas. The gases are returned to the headspace of the tank via a conduit so that the pressure therein is increased. The combined operation of the heater element and pressure builder coil allows the pressure within the tank to be increased very rapidly. When the pressure within the tank reaches a desired level, for example, 400 psig, the heater element is deactivated so that the thermodynamic pumping of cryogen to pressure builder coil stops. That patent is fully incorporated by reference herein, and the cryogenic liquid that is to be vaporized and used for quenching may be pressurized by this method.

U.S. Pat. No. 5,924,291 to Weiler et al., discloses a system and method that delivers cryogenic gas at a high pressure from a supply of cryogenic liquid maintained at a low pressure in a bulk tank, and the vapor generated by the heat exchanger is fed to the pressure building tank so that the high pressure therein is maintained. The bulk tank supplies liquid to at least one transfer tank that is pressurized by connecting it to a pressure building tank containing gas at a high pressure. A heat exchanger is connected in circuit between the transfer tank and the pressure building tank, and the transfer tank provides liquid at a high pressure to the heat exchanger so that a vapor is produced. Cryogenic liquid from the pressurized transfer tank provides a high pressure flow of liquid that may be dispensed to a vaporizer, which produces high pressure cryogenic gas. The gas may be fed to a high pressure gas storage tank so that high pressure cryogenic gas may be produced and stored. That patent is fully incorporated by reference herein, and the cryogenic liquid that is to be vaporized and used for quenching may be pressurized by this method.

Further, U.S. Pat. No. 6,505,469 to Drube et al., discloses a cryogenic vessel with an inner tank that contains cryogenic liquid, a head space above the liquid and a jacket surrounding the inner tank. An internal pressure builder coil is helically disposed about the inner tank, connected to the jacket and in communication with the bottom of the inner tank. An external pressure building heat exchanger is connected to the internal pressure builder coil and the head space of the inner tank. Liquid from the inner tank flows into the internal pressure builder coil, and causes liquid or a two-phase gas and liquid flow to travel up the pressure building line. The exiting fluid is driven by a resulting pumping action to the external pressure building heat exchanger where it is warmed and vaporized. The warmed gas is directed to the head space of the inner tank to rapidly build the pressure therein. This creates a pumping action that provides a continual flow of liquid into the inner pressure builder coil.

Gas may be dispensed directly from the headspace of the vessel via an economizer valve. Alternatively, liquid may be withdrawn from the inner tank by a dip tube and vaporized in a vaporizer and dispensed. That patent is fully incorporated by reference herein, and the cryogenic liquid that is to be vaporized and used for quenching may be pressurized by this method.

Also a manifold system such as that disclosed in U.S. Pat. No. 6,615,861 to Drube et al. may be used in conjunction with the prior art pressure building systems. Drube discloses an automated dispensing system allows that cryogenic liquid to be dispensed from either a primary bank manifold and associated cylinders or a secondary bank manifold and associated cylinders. Each manifold includes a gas header and a liquid header. The associated cylinders communicate with the gas header of the respective manifold through flexible lines and excess flow check valves and the liquid header through flexible lines and spring-loaded check valves. An automatic control system selects between dispensing from the primary bank manifold or the secondary bank manifold, while a pressure gauge detects the pressure of the cryogenic liquid from the dispensing manifold. The pressure gauge is in communication with a controller that opens and closes the appropriate valves to begin dispensing cryogenic liquid from the originally idle manifold if the detected pressure of the cylinders in use drops below a predetermined minimum. That patent is fully incorporated by reference herein, and the cryogenic liquid that is to be vaporized and used for quenching may be pressurized by this method.

Further, commercially available systems such as by MVE, Chart, Inc., or other such commercial pressurizing systems may be used to produce the pressurized cryogenic liquid that issued to produce the quenching gas. Further embodiments covered by one or more of the foregoing patents, or a design around of such patents may also be used to produce the pressurized cryogenic liquid that is vaporized and used for applications requiring large volumes of gas, such as quenching.

Also, the commercially available tanks such as the “Laser-Cyl” tank by MVE, may be used to hold the high pressure liquid that is produced prior to vaporization.

However, the prior art does not teach or disclose a method or system for producing a steady and reliable supply of quench gas that is economic, and that is produced from cryogenic liquid that is pressurized without the use of pumps or compressors. Therefore, there is an unmet need for a steady and reliable supply of quench gas that is economic and that does not have to rely upon parts and components that are costly to maintain and that break down, such as pumps that are typically used to pressurize the gas. In this connection, Applicants' have invented a method and system for producing large volumes of high-pressure gas for quenching heat treated and carburized parts more effectively and economically, than the prior art methods, apparatuses, and systems.

### BRIEF DESCRIPTION OF THE DRAWINGS

FIG. 1 is an illustration of the invention;

FIG. 2 is a schematic showing an aspect of the invention;

FIG. 3 is a schematic showing an aspect of the invention;

FIG. 4 is an illustration of the invention;

FIG. 5 is an illustration of a component of an embodiment of the invention;

FIG. 6 is an illustration of a component of an additional embodiment of the invention;

FIG. 7 is an illustration of a component of a further embodiment of the invention; and

FIG. 8 is an illustration of a component of another embodiment of the invention.

### DETAILED DESCRIPTION OF THE INVENTION

The present invention relates to processes and systems for making high-pressure gas used to quench or rapidly cool metals or other heated materials. Applicants' invention eliminates the need for pumps, compressors, and large high-pressure bulk storage tanks for producing quench gas, which are expensive, and which must be maintained. Gas produced by this method may also have a cooling advantage versus compressed gas produced by a compressor, which typically is heated as a result of compression. The apparatus used to produce such gas comprises at least one standard cryogenic bulk storage tank, at least one pressure building apparatus and at least one high-pressure vaporizer. The produced gas can be fed into a buffer tank, or used immediately after vaporization. The pressure building apparatus used in this invention takes advantage of the cryogenic properties of liquids and gases and allows the apparatus to increase the pressure of cryogenic liquids without pumps and compressors and achieve flow rates suitable for high-pressure gas quenching of metal parts and other uses. Multiple pressure building apparatuses can be placed in parallel, or in series, in order to ensure a constant supply of high pressure quenching gas and/or to allow the filling of buffer tanks. The gas from the buffer tank is then used for quenching, or other applications where high-pressure cryogenic gas is used or needed. Further more than one high-pressure buffer tank may also be used to ensure a steady and/or adequate supply of gas. Also, the gas may be used immediately after vaporization, without storing the gas in a buffer tank.

If desired, the buffer tanks may be temperature controlled.

Also, an embodiment of this method and system also includes a dew point monitoring feature that monitors the purity of the quench gas. Gas purity is important for uniform quenching and to ensure that the surface of the treated parts will not be damaged by, for example, water vapor. The use of inert or partially gas in the process of this invention serves to rapidly cool the hot metal pieces while also reducing the incidence of hazardous conditions such as fires and explosions that is associated with other types of gas. In order to increase the quenching speed with a given gas, the gas mass flow must be increased, that is, the speed and/or the static pressure of the quenching gas. The level of the quenching intensity that can be achieved is largely determined by the choice of gas, the pressure of the gas, the velocity/flow of the gas, and the gas temperature.

Among the generally used quenching gases, nitrogen is generally chosen and accepted in terms of cost and efficiency. Partially inert gases, include but are not limited to nitrogen and other gases that have low oxygen, hydrocarbon content, and/or carbon monoxide gas content. The inert or partially inert gas is used for quenching may also contain a minor amount of impurities such as oxygen and additional compounds which may even be reactive if in large quantities, but the quench gas primarily is comprised of inert and/or partially inert gases. The terms “inert gas” and “partially inert gas” as used herein specifically includes nearly pure gases and gas with such impurities. While nitrogen does not quench as rapidly as some of the inert gases and is only partially inert, it is often preferred to inert gases such as helium, argon and hydrogen, which are lighter and easier to convey under a relatively high pressure. Also, helium and argon are too expensive to use and hydrogen is too dangerous to use.

When gas such as nitrogen is chosen for quenching, large volumes must be produced, conveyed, and readied for use. This is especially a consideration for industrial gas quenching chambers that often have large volumes of several cubic meters, or more. Therefore, it is desirable to reduce the cost and increase the efficiency of the quenching step. Moreover, when nitrogen is used in this method, the gas atmosphere and the required mass flow is hardly negligible in the general cost of processing the part.

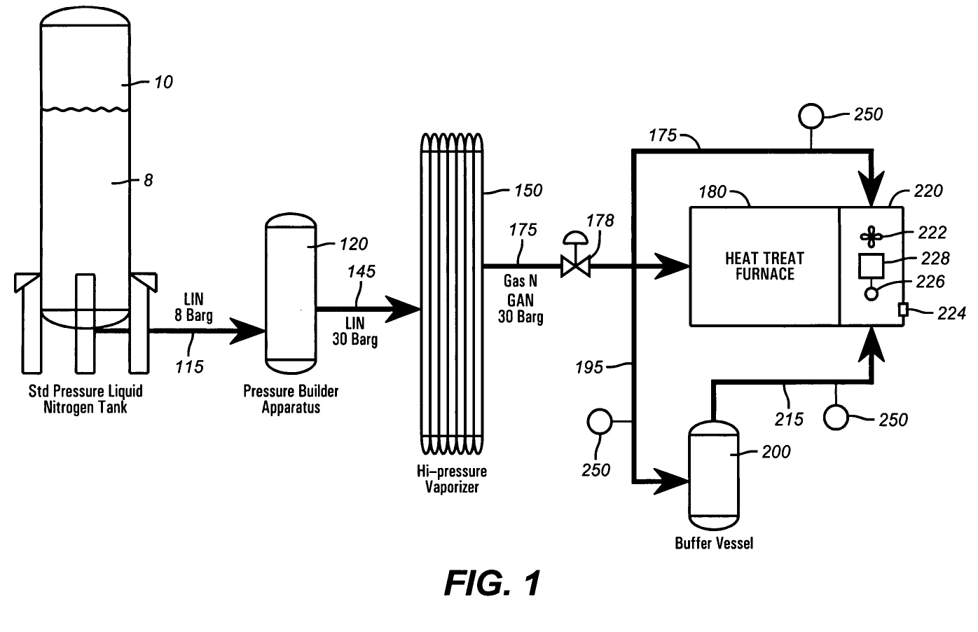

The invention is directed to a novel method and system for the production of high-pressure gas and the use thereof. As shown in FIG. 1, the invention comprises a standard bulk storage container 10 such as a bulk storage tank for storing a cryogenic liquid 8, such as nitrogen. Preferably the liquid is at least partially pressurized such as at pressures less than about 250 psig (about 17.24 bars), and may be 8 barg or less. Alternatively, cryogenic liquid from other sources such as a supply line or tanker truck and the like can be used. Preferably this liquid is at least partially pressurized. The invention also comprises at least one pressure building apparatus 120, which increases the pressure of the liquid cryogen without the use of pumps, or compressors. The pressure building apparatus is preferably isolated from the bulk storage container 10, such as by at least one valve. The bulk storage tank and the pressure building apparatus are connected to one another by a line or pipe 115, that is preferably insulated.

In an embodiment, a Chart Trifecta™ unit is used to increase the pressure of the liquid cryogen and is placed in between a bulk storage tank and a vaporizer. In alternate embodiments, one or more of the teaching of the preceding prior art patents, such as U.S. Pat. Nos. 5,937,655; 5,924,291; 6,505,469; 4,947,651 and/or 6,615,861 are used to produce the high pressure gas from cryogenic liquid that is pressurized with a pump or compressor. Further, systems sold by MVE or Chart and other commercially available systems that operate to pressurize liquid cryogens without the use of pumps of compressors may also be used. Moreover, a design around of the claims of such patents, a modification of the teachings of such patents, or a design around of such apparatuses may be used to increase the pressure of the liquid cryogen.

Generally, the Trifecta™ unit is configured with a bulk that tank supplies liquid to at least one transfer tank that is pressurized by connecting the transfer tank to a pressure building tank containing gas at a high pressure. The pressure building apparatus is separate from the tank used to supply the pressurized cryogen. A heat exchanger is connected in circuit between the transfer tank and the pressure building tank. The transfer tank provides liquid at a high pressure to the heat exchanger so that a vapor is produced, and this vapor is fed to the pressure building tank so that the high pressure therein is maintained. The pressurized transfer tank provides a high pressure flow of liquid that may be dispensed to a vaporizer that produces high pressure cryogenic gas.

Once the pressure of the cryogenic liquid has been increased to at least about 250 psig to about 400 psig and even about 450 psig or greater, and even up to about 500 psig by any of the foregoing means, the liquid is vaporized, preferably by a vaporizer 150. A line or pipe 145, which is preferably insulated connects the source of the pressurized liquid cryogen such as a pressure building apparatus 120 and a vaporizer 150, which is preferably a high-pressure vaporizer. See e.g., FIG. 1. In an embodiment, a Thermax ambient vaporizer, which has Air Liquide part number C808575, and has a maximum vapor generating pressure of 600 psig may be used. The high-pressure vaporizer 150 vaporizes the liquid into a gas having pressures of up to at least about 400 psig, or more and up to flows of about 2500 scfh to about 10,000 scfh (standard cubic feet/hour). Depending upon the desired pressure of the gas and the desired temperature of the cryogenic gas, other vaporizers known or used by one skilled in the art may also be used. If desired, a pressure control valve 178 may be used to control the pressure of the gas before the buffer tank 200 or quench chamber 220.

The high pressure gas may be fed to a high pressure gas storage tank so that high pressure cryogenic gas may be stored prior to use. In an embodiment, the vaporized gas is fed through an insulated line or pipe 195 into a buffer tank 200 to ensure a constant flow and to eliminate any pressure variations. The quench gas is stored in the buffer tank 200 at about 0° C. to about 60° C. The quench gas is then fed through another insulated line or pipe 215 into the quench chamber 220 at about 0° C. to about 60° C., or even up to about 200° C., although the speed of cooling will decrease as the temperature of the quench gas increases.

However, the vaporized gas may also be channeled directly to the furnace 180 or quench chamber 220 through a conduit 175, without first storing the gas or with or without using pressure regulating means such as a regulator. At lower pressures such as 250 psig, the gas may be delivered at flows of about 22,000 scfh, with the flows decreasing somewhat proportionally as the gas pressure is increased. A fan 222 or other circulating means may be placed within the furnace or quench chamber to facilitate circulation of the gas introduced into the furnace or chamber. At least one aperture 224 may be present in the furnace or chamber so that heated gas may exit. A thermo couple 226 or other temperature sensing means may be placed on or near the heat treated metal 228 to monitor the temperature of such metal. The thermocouple may be used to determine the flow, volume, and/or duration of the gas needed.

Preferably dew point monitoring 250 provides real-time or periodic monitoring of the resultant gas flow, purity, and moisture levels. The monitor may be coupled with a microprocessor that provides logging of excursions, and if desired historical trending and archiving. Further, the dew point monitoring may have an alarm feature to alert operators of any changes or problems in gas purity.

Additionally, by continuously monitoring dew points at various locations in the gas supply line, especially after vaporization and prior to use, users can detect any upsets or degradation of gas quality, thus reducing the likelihood of damaged parts due to oxidation or decarburization.

Opening and closing means such as valves like electromechanical solenoid valves, mechanical check valves, or other types of valves that preferably direct a one-way flow between the tanks, storage vessels, and quench chamber may also be used. Further, regulators may be used to maintain and/or ensure proper pressure, and pressure relief valves and burst disks that are known or used by one skilled in the art may be added at various points for operability and/or for safety. Also, in an embodiment, at least one strainer is used to strain out precipitates, such as that coming from the bottom of the bulk storage tank.

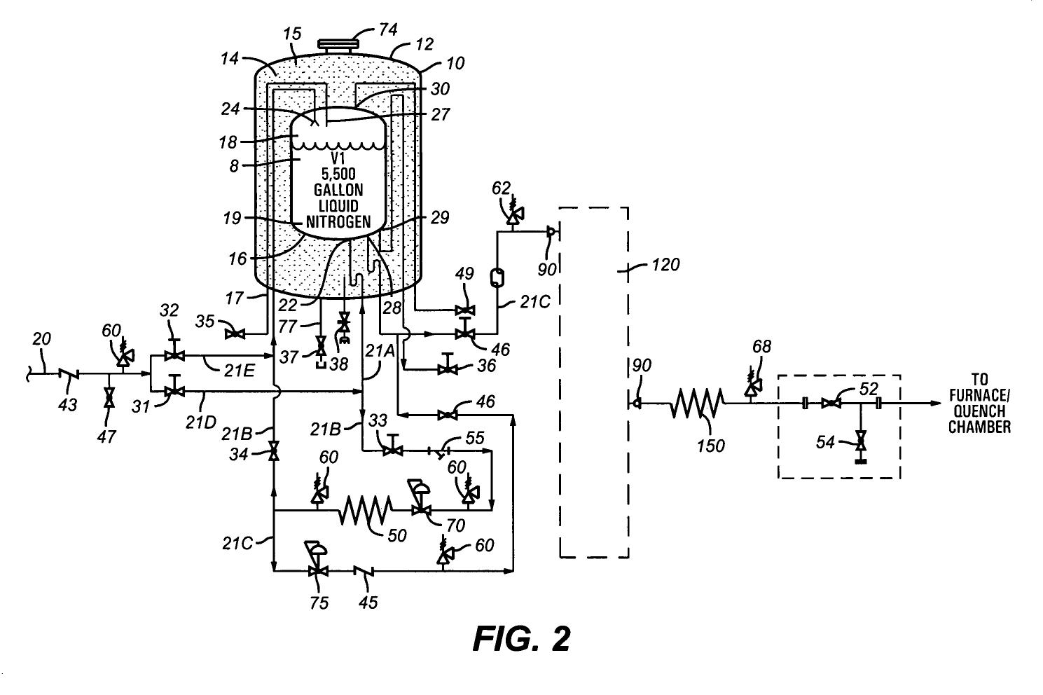

The storage vessel such as a bulk storage tank 10 as well as the lines, valves, and components may comprise a variety of different parts and components known to one skilled in the art and may be configured in a variety of ways. For example, as shown in FIG. 2, the tank 10 may be a vacuum insulated storage tank having an inner vessel 16 which actually holds the cryogenic liquid 8, an outer shell 12, and an area or layer between the inner vessel and the outer shell known as the annular space 14. The annular space 14 is typically filled with insulating material 15 such as perlite or other such materials known or used by one skilled in the art. Once the annular space is filled with such insulating material, the gas within the annular space is preferably evacuated. For example, a vacuum pressure line 38 can be attached to a valve 37 or alternatively a port which is attached to or that connects to an outer line 77. Further, the vacuum line 38 may also extend into the annular space.

There is at least one supply line 20 that is used to replenish the liquid cryogen stored in the bulk tank. Depending upon, for example, the pressure in the inner tank, the tank can be refilled with the liquid cryogen through the top into the head space 18 or through the bottom 19 of the tank. A hand valve 47 may also be installed along the supply line to prevent back flow into the supply line when the supply line is not in use. Towards the storage vessel, it is also preferable to include at least one check valve 47 to facilitate a one-way flow and to prevent back flow into the supply line. Further, the piping to the vessel and the valves can be configured to allow a top filling of the vessel and/or a bottom filling of the vessel, depending upon the temperature and pressure of the head space in the vessel and the liquid cryogen in the vessel. For example, in an embodiment, the supply line may be bifurcated to two fill lines 21D, 21E with a valve e.g. 31, 32 on each side of the bifurcation that can be opened or closed to direct the cryogen to the desired location in the storage vessel. As shown in FIG. 2, when valve 31 is open, fill line 21D may feed directly into piping 21A that is connected to the bottom of the vessel and facilitates a bottom fill 22. Further, at least a portion of the cryogen in fill line 21D may instead lead to a vaporizer/heat exchanger 50 and be heated and perhaps even vaporized with at least a portion of the vapor facilitating a top fill 24 of the vessel by opening valve 34 and by channeling the vaporized cryogen into the head space 18 of the vessel. For safety purposes, there may also be an inline strainer 55, a pressure safety valve 60, and several pressure control valves 70, 75, such as one rated to about 150 psig to about 200 psig that controls the pressure of the cryogen prior to entry into the vaporizer/heat exchanger 50. In an embodiment of FIG. 2, there is a pressure safety valve 60 on either side of the vaporizer/heat exchanger 50. Line 28 is a liquid use line and line 29 is a liquid withdrawal line.

The type of pressure safety valves designated as 60 are preferably valves rated to about 330 psig.

There may also be a full trycock 27 that leads to the head space of the tank and that has a line that extends outside the vessel and outer shell that has a valve 35 on its terminating end that is used to prevent overfilling of the inner vessel during the filling of the vessel.

Further, a vapor return line 30 may be installed that is capped by a valve 49 at the terminating end of the line. Line 29, a liquid withdrawal line may also be capped by a valve 36.

In an embodiment, the pressure building apparatus 120 may comprise a use vessel that has means within or attached to the use vessel that vaporizes a portion of the cryogen to gas that is directed to the headspace of the use vessel. Alternatively a separate pressure building apparatus may instead vaporize a portion of the cryogen to gas that is directed into the headspace of the use vessel.

In an embodiment of FIG. 2, a line 21c that holds liquid cryogen has a pressure control valve 75 in front of a swing check valve 45 which leads to a pressure safety valve 60 then hand valves 46, 48 and another pressure safety valve 62 in order to control the flow of cryogen leading to the pressure building apparatus 120 and prevents over-pressurization and damage to the lines and/or pressure building apparatus 120. These valves may be configured differently or placed in other locations, and are primarily related to the control and safety of the apparatus and method.

Alternatively, the partially heated cryogen may instead flow through a use line 21C to a pressure-building apparatus 120. Additionally, liquid cryogen may be withdrawn from the vessel and fed through a use line 21C that leads to the pressure-building apparatus 120.

Again a variety of safety devices such as pressure control valves, such as those rated to about 200 psig, and pressure safety valves may be installed along the lines and piping as a safety precaution to prevent over pressurization of the inner vessel. Further various connectors such as reducers 90, may be used to fit lines of varying sizes together. In an embodiment, the lines upstream and downstream of the pressure building apparatus 120 are 1-inch lines while lines leading to a Trifect™ pressure building apparatus are 1/2 inch in diameter.

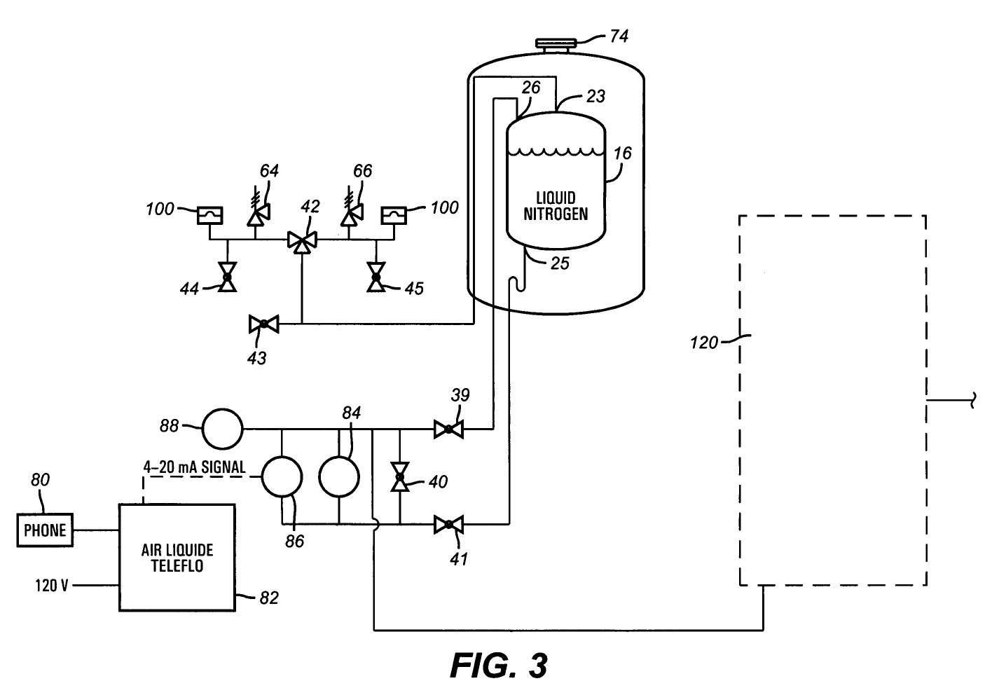

Further, as shown in FIG. 3, a vent 23 may be installed into a top portion of the inner vessel to vent the vessel to prevent rupturing of the tank due to overfilling or pressure changes within the inner vessel. Also in an embodiment, a pressure thermal safety valve 74 may be installed to prevent rupturing of the tank due to overfilling or pressure changes within the inner vessel. In an embodiment, a variety of valves known to one skilled in the art, such as valves 43, 44, 45, that are in an embodiment hand valves, are placed at the terminating ends of the piping may be opened and closed to facilitate the venting of the vessel. Further valve 42 may open and close and lead to pressure safety valves 64, 66, such as those preferably rated to about 330 psig that may further be placed in line with rupture safety disks 100, 102 to prevent the blow out of pressure safety valves 64, 66, and especially valves 44, 45. Also in an embodiment, a pressure safety valve preferably rated to about 500 psig is placed downstream of the vaporizer 150, and control valves such as 52, 54 are placed before the chamber or buffer tank. See e.g., FIG. 2. Further as shown in FIG. 2, gauges 84, 86, 88 that monitor the liquid phase 25 and the gas phase 26 in the inner vessel 16 may be used in an embodiment in conjunction with a method and system that ensures timely refilling of the liquid cryogen. For example, this method and system also may include an automated system for monitoring the temperature, pressure, and level of liquid cryogen in the bulk storage tank that automatically calls in a reorder for refilling the storage tank via a phone line to ensure a sufficient amount of cryogen is available for gas production. See FIG. 3. In an embodiment, a system such as the Air Liquide Teleflo™ system 82 may be utilized to monitor the level of the cryogenic liquid in the bulk storage tank and to facilitate automated reordering of the cryogen. See FIG. 3. The Teleflo™ system comprises a pressure gauge 88, a level gauge indicator 84, and a differential transmitter that all send signals and data to the Teleflo™ system that can be monitored remotely by phone and which upon programming may send such data to a chosen location. The Teleflo™ system is also configured with valves 39, 41 and a phone line 80, and may include a modem or Internet connection.

Again, a single pressure building apparatus may be used to pressurize the liquid cryogen, or a plurality of pressure building apparatus may be configured in parallel or in series so that each vessel can be used alone or in conjunction with other the vessels to allow continuous flow to a vaporizer and a continuous gas supply. The plurality of pressure building apparatuses that are configured in series or in parallel also have a level of redundancy that allow at least one vessel to be on line while at least one other vessel is being filled and pressurized. There are a variety of pressure building apparatuses that can be used in this invention, such as the Trifecta™ unit by Chart. Preferably, the pressure building apparatus increases the pressure of the liquid cryogen to more than about 250 psig to about 450 psig, and does so without the use of pumps or compressors.

An advantageous apparatus and method of supplying high pressure gaseous nitrogen or argon to the quenching chamber uses a Trifecta™ supplied by Chart Industries in line and in between a standard nitrogen storage tank and a high pressure vaporizer. The Trifecta™ has no moving parts, and solenoid valves control the flow and direction of the gas. The Trifecta™ model 10K can facilitate a pressurized cryogenic gas flow of up to 10,000 scfh (standard cubic feet/hour) (269.9 cubic NM) or greater at up to about 460 psig (31.7 bar). The Trifecta™, or similarly configured embodiment is preferably an automatic, computer-controlled system, which enables a continuous flow of gas, and even maintains continuous flow even when the bulk tank is being filled. The Trifecta™ system by Chart incorporates two different vessels that have an internal vaporizer or an integral vaporizer for each tank. The pressure building apparatuses are isolated from the storage tank so the pressure building apparatuses are at least partially filled and isolated, and the standard pressure e.g., 12 bar (174 psi) is goaded up to about 30 bar (435 psi) by vaporizing a portion of cryogenic liquid and feeding the gas into the head portion of the tank. It further has an automatic fill and continuous pressure monitoring with a computerized control center.

In operation of the Chart Trifecta™ system, or similarly configured components, high-pressure quench gas can be obtained without having to include a compressor or pump. This improvement also reduces capital costs and space requirements because now, instead of storing liquid cryogen in three tanks at 12 bars (174 psig), one tank at 30 bars (435 psig) can be used, which produces about the same or greater amount of quench gas for delivery into the chamber(s). The quench chambers may be separate from the furnaces or can be incorporated into the heat treating furnaces. Also, producing quench gas by this method eliminates bulky on-site tube trailers.

Similarly, other types of pressure building apparatus can for cryogens that operate without the used of pumps and compressors that are known or used by one skilled in the art may be used in this invention.

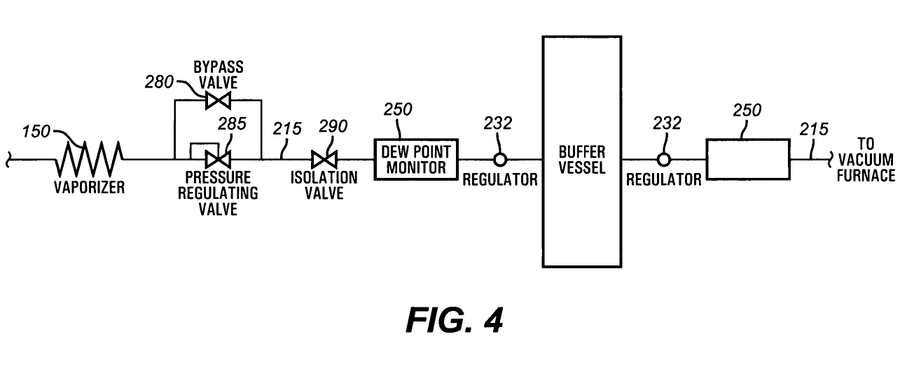

As shown in FIG. 4, after the pressure of the liquid cryogen is increased in the pressure building apparatus, the liquid is vaporized, preferably by a vaporizer 150. Another insulated line or pipe 145 connects the pressure building apparatus 120 and the vaporizer 150, which is preferably a high-pressure vaporizer. The high-pressure vaporizer 150 vaporizes the liquid into a gas having pressures of up to about 450 psig (31 bars) and up to about flows of about 10,000 scfh to about 22,000 scfh or greater.

The quench gas is then fed through a piping 215 into the quench chamber 220 at preferably about 0° C. to about 60° C., or even up to about 200° C., although the speed of cooling will decrease as the temperature of the quench gas increases.

However, the vaporized gas may also be channeled directly to the furnace 180 or quench chamber 220, with or without using pressure-regulating means such as a regulator. Also, in an embodiment there is a bypass valve 280, a pressure regulating valve 285, and an isolation valve 290 for safety and efficiency. Regulator 232 may be used before the buffer vessel and regulator 230 maybe used before the dew point monitor 250 or quench chamber.

Additionally, at least a portion of the vaporized gas may also be stored in a high-pressure buffer tank 200 or vessel prior to use and prior to being sent to the furnace 180 or quench chamber 220.

Opening and closing means such as valves, such as electromechanical solenoid valves or other types of mechanical check valves that preferably direct a one-way flow between the tanks, storage vessels, and quench chamber may also be used. Further, regulators may be used to maintain and/or ensure proper pressure, and pressure relief valves and burst disks may be added for safety. At lower pressures such as 250 psig, the gas may be delivered at flows of about 22,000 scfh, with the flows decreasing somewhat proportionally as the gas pressure is increased.

This invention covers a method of pressurizing and dispensing cryogenic liquid without using a pump or compressor for the production of high pressure gas used in quenching applications, which comprises: storing cryogenic liquid in a low pressure bulk storage tank at pressures less than about 250 psig, introducing the stored cryogenic liquid into a use vessel 312, such through conduit 316, converting a portion of the cryogenic liquid from the storage tank into gas by heating the portion of liquid, and increasing the vessel pressure of the liquid in the use vessel of at least about 250 psig to about 500 psig by feeding a portion of the gas into a head portion of the use vessel above the liquid. Further, a use line 346 in communication with the use vessel is provided so that cryogenic liquid can be dispensed therefrom and pressurized liquid from the use vessel is sent into a vaporizer that vaporizes the liquid into a high-pressure gas of at least about 250 psig to about 500 psig. Thereafter, the gas is delivered into a chamber that contains heat-treated parts at pressures greater than at least about 250 psig and flows of about 10,000 scfh or greater, and the gas at least partially quenches and cools the heat treated parts.

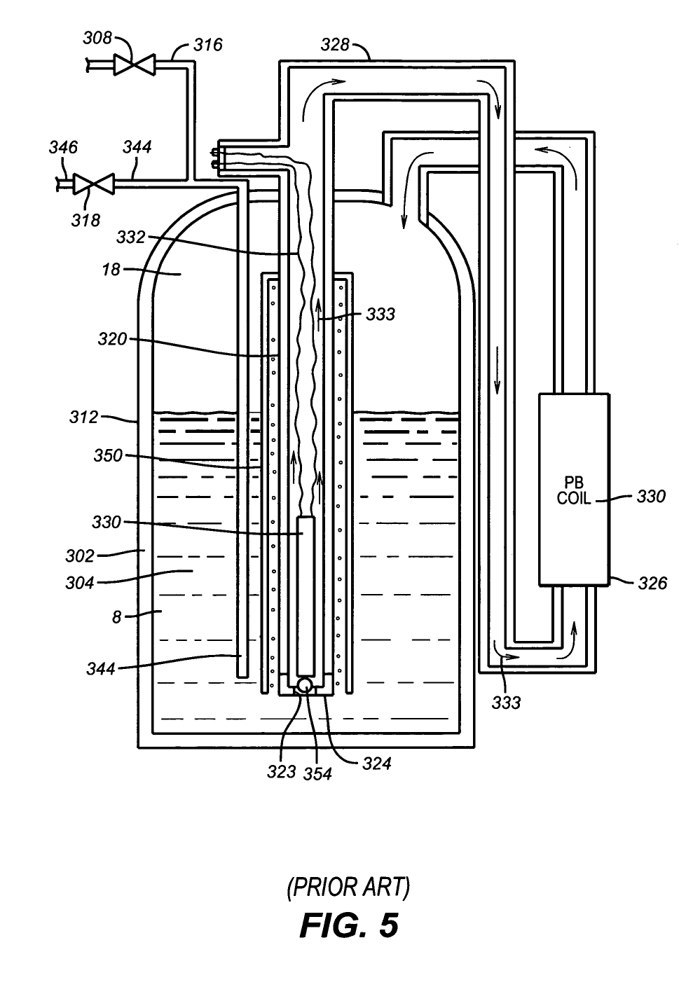

In an embodiment of this method a pressure building device like that taught in U.S. Pat. No. 5,937,655 that is incorporated fully by reference is used to pressurize cryogenic liquid. Therein, a tubular enclosure 320 disposed within the use vessel 312 and the enclosure has an opening 323 that permits a portion of cryogenic liquid 8 within the use vessel to enter the tubular enclosure, wherein a first heating element 330 is disposed and which heats the cryogenic liquid within the enclosure and converts a part of the liquid into the gas. The enclosure may be surrounded by an insulating portion 350. The vapor thus produced exits the vessel through the conduit 328. As vapor continues to exit the conduit 328, a suction or siphon type effect is created. This creates a flow 333 of vapor and liquid cryogen into the conduit. See FIG. 5. Electrical leads 332 extend outside the sealed vessel so they can connect to a source of electricity for the heating element 330. Also in this method, there may be a second heating element within the conduit, such as a pressure builder coil 326 wherein the flow 333 of gas and liquid cryogen reaches the coil, the remaining liquid is vaporized to gas. The vaporized gas from the tubular enclosures and the pressure builder coil is conveyed into the headspace 18 of the use vessel of a conduit 328 thereby increasing the pressure within the vessel.

A spherical member 354 may be positioned near the bottom 324 of the tubular enclosure to act as a thick valve and prevent heated cryogenic fluid from flowing back into the use vessel.

Also, there may be a liquid delivery tube 334 in the vessel, wherein the cryogenic liquid of increased pressure is dispensed from the vessel to a vaporizer. Valves 308, 318 control the filling and dispensing of cryogenic liquid.

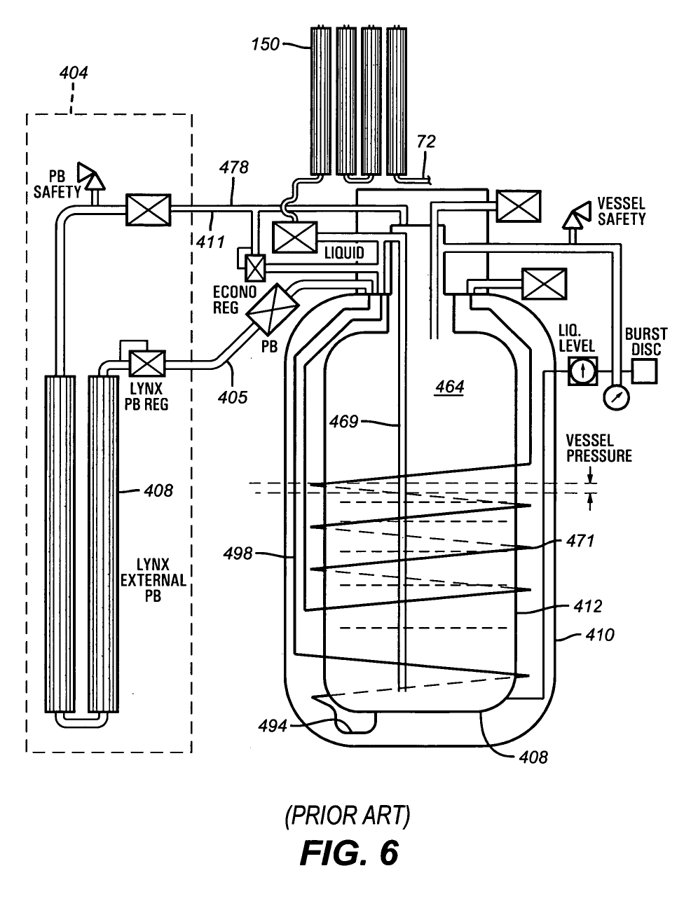

In this method, the use vessel may comprise a jacket 410 and an inner vessel space and wherein an internal pressure builder communicates 471 with the inner vessel space 408 and whereby cryogenic liquid from the inner tank 408 flows into the internal pressure builder 471 that heats a portion of the liquid and produces gas. See FIG. 6. A pressure builder coil 471 is connected to the bottom of the inner tank 8 is disposed about the tank and is in contact with jacket 10. The cryogenic liquid is able to flow from the inner tank into the coil, and heat transferred between the external environment and the liquid in the coil is vaporized. The headspace 464 of inner tank 408 holds cryogenic vapor that forms due to the transfer of heat between the external environment and the interior of the inner tank 408. Further, if desired a flow of cryogenic gas and/or liquid may be delivered through line 405 to an external pressure building circuit 404 to provide cryogenic gas that flows through line 411 to the headspace 464 to pressurize the vessel.

Also, this method may further comprise the steps of: providing an external pressure building heat exchanger 426 in communication with the internal pressure builder 471 and the head space 464 of the use vessel, wherein heat from the internal pressure builder 471 causes liquid to flow to the heat exchanger 426 where the fluid is heated and produces gas, and the produced gas is delivered to the head space 464 of the use vessel, thereby pressurizing the vessel. This method uses a pressure building device like that taught in U.S. Pat. No. 6,505,469, which is fully incorporated by reference. Dip tube 469 communicates with a valve 470 enables the liquid to be dispensed to an external vaporizer 150. The produced gas then is conveyed through line 472 to a quench chamber.

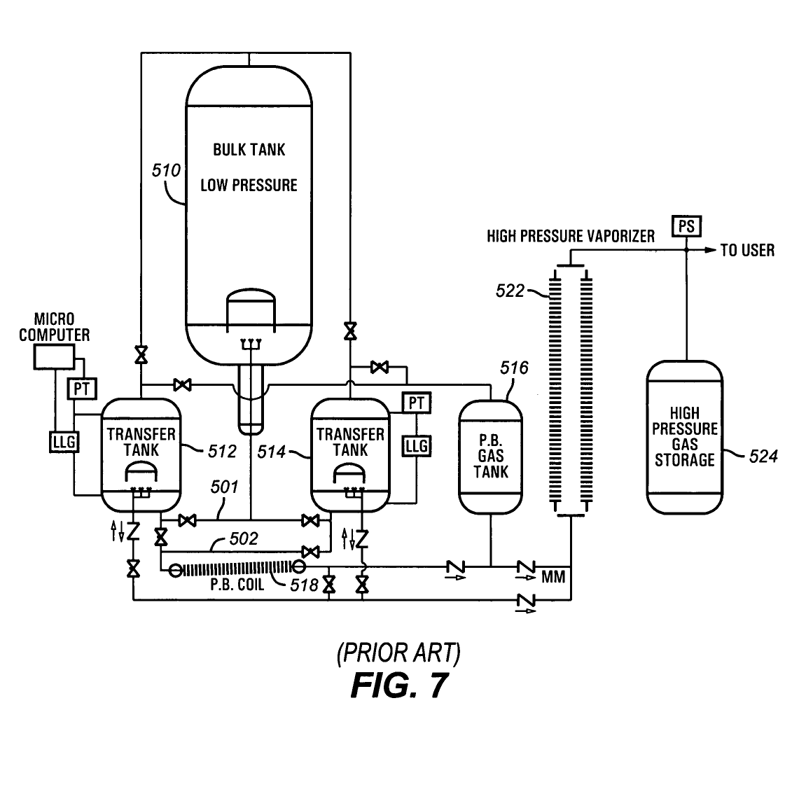

Also in a further embodiment of this method, a bulk storage tank 510 that contains a supply of cryogenic liquid is provided, and a pressure building tank 516 selectively communicates with at least one use vessel, e.g., 512, 514 to pressurize the use vessels and a heat exchange means such as pressure building coil 518 is placed in circuit between the at least one use vessel 512, 514 and the pressure building tank to selectively vaporize a portion of the cryogenic liquid from the use vessel into gas to recharge and maintain the pressure in the pressure building tank. The pressurized cryogenic liquid is then vaporized in a high pressure vaporizer 522. The gas is then used and/or stored in a high pressure gas storage tank 524. A variety of valves are used to control the pressure and/or flow. See FIG. 7. This method uses a pressure building device like that in U.S. Pat. No. 5,924,291, which is fully incorporated herein by reference.

In this method, the use vessel may also comprise a first use vessel 512 and a second use vessel 514, wherein means such as lines 501, 502 at least temporarily connect the first use vessel and the second use vessel.

Also in this method, the first use vessel and the second use vessel may be temporarily connected and the first and second vessel may be nearly equalized in terms of internal pressure.

Further in this method, once the liquid cryogen is pressurized and vaporized by any of the foregoing methods the dew point of the high-pressure gas may be monitored 250 prior to delivering the gas into the chamber 220.

Additionally, at least a portion of the high pressure gas may be stored in at least one buffer tank 524 prior to delivering the gas into the chamber. And, the dew point of the gas may be monitored 250 prior to use and/or before storing the gas and/or after storing the gas. See e.g., FIG. 4.

Further in this method, the high-pressure gas may be delivered to the chamber during and/or after carburization and during and/or after heat treatment.

As part of this method, the high-pressure gas may comprise at least one gas selected from the group that consists essentially of nitrogen, argon, helium, or a combination thereof.

And, the high-pressure gas may be delivered into the chamber at flows of at least about 10,000 to about 22,000 scfh. Further, the high pressure gas may be delivered into the chamber at pressure ranges between at least about 250 psig and flows of at least about 22,000 scfh and pressures of up to about 450 psig or greater and flows of at least about 10,000 scfh.

Additionally in all the foregoing embodiments, a plurality of use vessels may be utilized, and at least one of the plurality of use vessels can be used to supply pressurized liquid to the vaporizer to allow continuous delivery of the gas into the chamber. Further, the plurality of supply vessels may be configured in series or in parallel, so as to have a level of redundancy, and at least one use vessel on line for use while at least one other use vessel is being filled and/or pressurized.

In this method, the high-pressure gas may be delivered into the chamber at about 0 degrees Fahrenheit to about 200 degrees Fahrenheit.

Also, the level of liquid cryogen in the bulk storage tank may also be monitored and an automated system may be used to order a refill for the bulk storage tank when the cryogen decreases to a predetermined level.

Further, a control means may be used between the vessels and/or tank, wherein the control means is selected from the group consisting essentially of a valve, a regulator, a pressure control valve, a safety valve, a solenoid valve, an isolation valve, an equalization valve, a rupture disc safety relief, or a combination thereof.

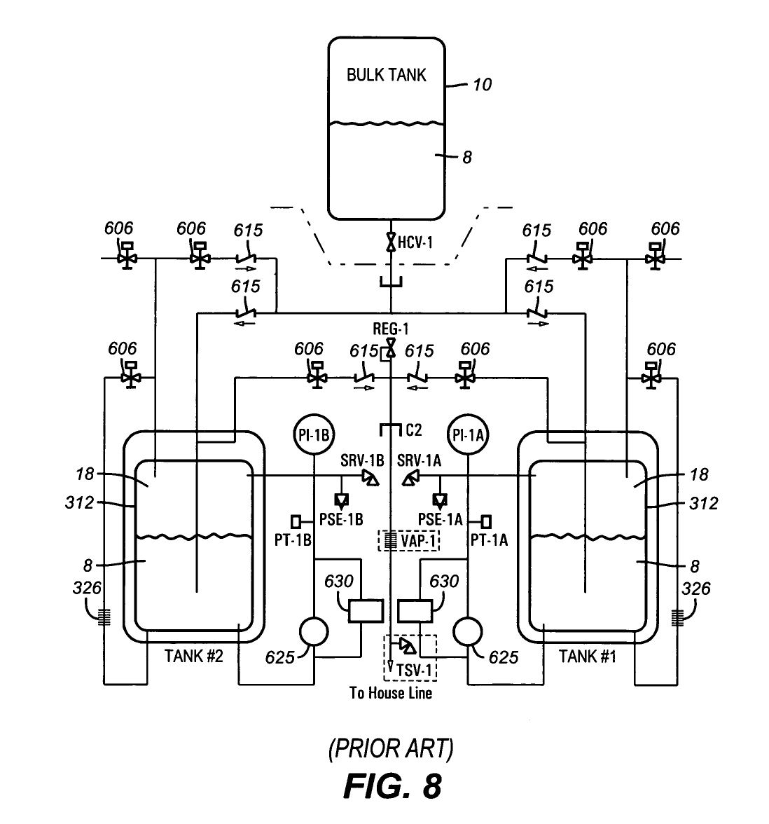

Again, a Trifecta™ unit can be used to produce the pressurized liquid cryogen. Generally, the Trifecta™ is used in conjunction with a bulk storage tank 10 that holds a supply of liquid nitrogen 8. See FIG. 8 The storage tank is connected to the Trifecta™ that comprises at least two use vessels 312, 314 with a pressure building coil 326 that vaporizes a portion of the cryogenic liquid that is fed into the head space 18 of the use vessels. A plurality of solenoid valves 606 and check valves 615 control the flow of the cryogenic liquid and/or gas. Level indicator 625 and level transmitter 630 are also included, as are pressure indicators, safety relief valves, and rupture disk safety reliefs. The pressurized liquid is sent to a vaporizer 650 and the produced gas is sent to a quench chamber 220. Again, the gas may be stored before it is sent to the quench chamber.

Also, this invention includes a method of producing of high pressure gas for quenching applications from cryogenic nitrogen liquid that is pressurized without the need of a pump or compressor that comprises: obtaining cryogenic liquid comprising nitrogen, storing the cryogenic liquid in a low pressure bulk storage tank at pressures less than or about 250 psig, introducing the stored cryogenic liquid into a use vessel, leaving a portion of head space above the liquid, increasing the pressure of the cryogenic liquid in the use vessel by using a pressure building apparatus that does not need a pump or compressor by vaporizing a portion of cryogenic liquid into gas and sending at least a portion of the gas into a head portion of the use vessel, feeding pressurized liquid from the use vessel into a vaporizer that vaporizes the liquid into a high-pressure gas of at least about 250 psig and up to about 500 psig, delivering the gas into a chamber that contains heat treated parts at pressures greater than about 250 psig and flows of about 10,000 scfh or greater, and at least partially quenching and cooling the heat treated parts with the gas.

Also in this method, the level of stored cryogenic liquid in the bulk storage tank may be monitored and the cryogenic liquid for the bulk storage tank can be automatically monitored and reordered.

Further as part of this method, a Trifecta™ can be used as a source of pressurized liquid.

Also, the dew point of the high pressure gas from the vaporizer can be monitored prior to delivering the gas to the chamber.

Additionally, the high pressure gas from the vaporizer may be stored in a buffer tank prior to delivering the high pressure gas to the chamber. And, the dew point of the high pressure gas from the buffer tank may be monitored prior to delivering the gas to the chamber.

In this method, the high pressure gas can be delivered to the chamber continuously for a predetermined time periodically until the heat treated parts are at least partially cooled. Further, the temperature of the gas may be monitored prior to delivery into the chamber.

The temperature of the chamber and/or heat treated metal and parts may also be monitored by various means known to one skilled in the art during the quenching and cooling of the parts.

Also, there may be at least one outlet in the chamber for the exit of the heated gas means to capture and recycle the quench gas that has become heated may also be used.

Another method that is contemplated by this invention is a high pressure cryogenic gas quenching method for carburized and/or heat treated metal or metal alloys which comprises: carburizing and/or heat treating metal in a heating chamber, placing the carburized and/or heat treated pieces in a quench chamber, quenching the pieces to a desired temperature and/or for a desired time with high pressure gas produced from cryogenic liquid, wherein the liquid is at least partially pressurized up to at least about 250 psig to about 450 psig without using a pump or compressor. The quench gas is delivered at pressures between about 250 psig and about 450 psig and flows from about 10,000 scfh to about 22,000 scfh into the quench chamber, and the quench gas at least partially cools the parts.

Also as part of this method, inert and/or partially inert cryogenic liquid is provided and stored at cryogenic temperatures in a bulk storage tank at pressures less than or about 250 psig, and at least a portion of the liquid is fed into a use vessel and/or a pressure building vessel. Next, the pressure of the liquid in the use vessel is increased to at least about 250 psig up to about 450 psig, and the pressurized liquid cryogen is sent to a high pressure vaporizer.

In this method, a Trifecta™ can be used to pressurize the cryogenic liquid prior to vaporization.

Further, the vaporized gas can be fed into a buffer tank before it is introduced into the quench chamber. The cryogenic gas can be stored in the buffer tank at about 0° C. to about 60° C., or less, and the cryogenic gas enters the quench chamber at about 0° C. to about 60° C. or greater. The gas may be fed into the quench chamber at pressures of up to about 450 psig and flows of at least about 10,000 scfh.

The high-pressure gas comprises at least one gas selected from the group that consists essentially of nitrogen, helium, argon, or a combination thereof.

There is also a heated treated metal or metal alloy product manufactured by this method.

Also, this invention includes a system for quenching heat treated metal without using oil to quench the parts, that comprises: inert and/or partially inert cryogenic liquid stored in a low pressure bulk storage tank at pressures less than or about 250 psig, a use vessel that stores the cryogenic liquid at pressures at least about 250 psig to about 500 psig, a means for increasing the pressure of cryogenic liquid to pressures of at least about 250 psig to about 450 psig, wherein the liquid is pressurized without the use of a pump or compressor, means for converting a portion of the pressurized cryogenic liquid into cryogenic gas, and a means for transferring at least a portion of the converted cryogenic gas into the use vessel. A vaporizer vaporizes the high pressure liquid into a high-pressure gas of at least about 250 psig to about 450 psig is used, and a chamber contains heat treated parts, wherein the high pressure gas is introduced into the chamber at pressures greater than about 250 psig and flows of about 10,000 scfh or greater, thereby at least partially quenching and cooling the heat treated metal.

Further, the high-pressure gas may be delivered into the chamber at flows of at least about 10,000 to about 22,000 scfh. Also, the high pressure gas can be injected into the chamber at pressure ranges at least about 250 psig and flows of at least about 22,000 scfh and between pressures of about 450 psig and flows of at least about 10,000 scfh. In this system, a pressure building apparatus is used as a means to increase the pressure of cryogenic liquid and wherein at least a portion of the cryogenic liquid is vaporized in a pressure building apparatus.

In this system, the pressure building apparatus may be comprised of a Trifecta™ unit.

This system may further comprise a dew point monitor that monitors the dew point of the high-pressure gas after vaporization and prior to delivering the gas into the chamber.

Also, there may be at least one buffer tank for storing at least a portion of the high pressure gas prior to delivering the gas into the chamber.

The system may also comprise a dew point monitor that monitors the dew point of the high-pressure gas prior to storing the gas in the buffer tank prior to introducing the gas into the chamber.

In this system, the high-pressure gas may comprise at least one gas selected from the group that consists essentially of nitrogen, argon, helium, or a combination thereof.

A plurality of Trifecta™ units may also be used in this system and the units can be configured in parallel and/or in series.

In this system the high pressure gas can be delivered to the chamber continuously for a predetermined time, or the high pressure gas can be delivered to the chamber periodically until the heat treated parts are at least partially cooled.

Also the system may comprise a means for monitoring the temperature of the gas prior to delivery into the chamber and/or a means for monitoring the temperature of the chamber during the quenching and cooling of the parts.

There may also be an outlet in the chamber for the exit of the gas that has become heated.

Further, the system may comprise a means such as a fan or blower or other apparatuses known to one skilled in the art for circulating the high pressure gas in the chamber.

Also there may be a means for capturing and recycling at least a portion of the quench gas used in the chamber.

In this system, the high-pressure gas can be delivered into the chamber at about 0 degrees Fahrenheit to about 200 degrees Fahrenheit.

There may also be a means for monitoring the level of liquid cryogen in the bulk storage tank and an automated system that orders a refill for the bulk storage tank when the liquid cryogen decreases to a predetermined level.

Also, the system may have at least one control means and the control means may be selected from the group consisting essentially of a valve, a regulator, a pressure control valve, a safety valve, a solenoid valve, an isolation valve, an equalization valve, a rupture disc safety relief, or a combination thereof.

It is to be understood that the invention may assume various alternative structures and processes and still be within the scope and meaning of this disclosure. Further, it is to be understood that any specific dimensions and/or physical characteristics related to the embodiments disclosed herein are capable of modification and alteration while still remaining within the scope of the present invention and are, therefore, not intended to be limiting. It will be understood that many additional changes in the details, materials, steps and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

1. A method of pressurizing and dispensing cryogenic liquid without using a pump or compressor for the production of high pressure gas used in quenching applications, comprising:
storing cryogenic liquid in a low pressure bulk storage tank at pressures less than about 250 psig;
introducing the stored cryogenic liquid into a use vessel;
converting a portion of said cryogenic liquid from said storage tank into gas by heating said portion of said liquid;
increasing the vessel pressure of said liquid in said use vessel to about 250 psig to about 500 psig by feeding a portion of said gas into a head portion of said use vessel above said liquid;
providing a use line in communication with the use vessel so that cryogenic liquid can be dispensed therefrom;
sending pressurized liquid from the use vessel into a vaporizer that vaporizes said liquid into a high-pressure gas of at least about 250 psig to about 500 psig;
delivering said gas at pressures greater than at least about 250 psig and flows of about 10,000 scfh or greater into a chamber that contains heat treated metal; and
at least partially quenching and cooling said heat treated metal with said gas.

2. The method of claim 1, further comprising the steps of:
placing a tubular enclosure within the use vessel, said enclosure having an opening that permits a portion of cryogenic liquid with said use vessel to enter said tubular enclosure; and
placing a first heating element within said tubular enclosure which heats the cryogenic liquid within said enclosure and converts a part of said liquid into said gas.

3. The method of claim 2, wherein a conduit conveys the gas into the head space of said use vessel.

4. The method of claim 3, wherein the heating of said liquid creates a pumping action and a flow of liquid and gas into said conduit and wherein a second heating element is disposed within said conduit, wherein the flow of liquid cryogen is vaporized to gas and wherein said vaporized gas from said first and second heating elements are conveyed into the head space of said use vessel.

5. The method of claim 1, further comprising the step of placing a liquid delivery tube in said vessel, wherein the pressurized cryogenic liquid is dispensed from said vessel to said vaporizer.

6. The method of claim 1, wherein the vessel pressure is increased by an internal pressure builder that communicates with said use vessel, whereby cryogenic liquid from said use vessel flows into said internal pressure builder that heats said liquid and produces said gas.

7. The method of claim 6, further comprising the steps of:
providing an external pressure building heat exchanger in communication with said internal pressure builder and the head space of the use vessel wherein heat from the internal pressure builder causes liquid to flow to said heat exchanger wherein said fluid is heated and produces gas; and
delivering said produced gas from the internal pressure builder and the heat exchanger to the head space of said use vessel, thereby pressurizing said vessel.

8. The method of claim 1, wherein the vessel pressure is increased by using a pressure building tank that contains a supply of cryogenic liquid, said pressure tank selectively communicating with said use vessel to pressurize said use vessel; and
wherein a heat exchange means is placed in circuit between the use vessel and the pressure building tank to selectively vaporize a portion of the cryogenic liquid from the use vessel into gas to recharge and maintain the pressure in said pressure building tank.

9. The method of claim 8, wherein the use vessel comprises a first use vessel and a second use vessel and wherein means at least temporarily connects the first use vessel and the second use vessel.

10. The method of claim 9, further comprising the steps of:
temporarily connecting the first use vessel and the second use vessel; and
nearly equalizing said first and second vessel in terms of internal pressure.

11. The method of claim 1, further comprising the step of monitoring the dew point of said high-pressure gas prior to delivering said gas into the chamber.

12. The method of claim 1, further comprising the step of storing at least a portion of said high pressure gas into at least one buffer tank prior to delivering said gas into the chamber.

13. The method of claim 12, further comprising the step of monitoring the dew point of said gas prior to storing said gas.

14. The method of claim 1, wherein said high-pressure gas is delivered to the chamber during and/or after carburization.

15. The method of claim 1, wherein said high-pressure gas is delivered to the chamber during and/or after heat treatment.

16. The method of claim 1, wherein said high-pressure gas comprises at least one gas selected from the group that consists essentially of nitrogen, argon, helium, or a combination thereof.

17. The method of claim 1, wherein said high-pressure gas is delivered into said chamber at flows of at least about 10,000 to about 22,000 scfh.

18. The method of claim 1, wherein said high pressure gas is delivered into said chamber at pressures of about 250 psig up to about 450 psig.

19. The method of claim 1, further comprising the step of having a plurality of use vessels, wherein at least one of said plurality of use vessels supplies pressurized liquid to said vaporizer to allow continuous delivery of the gas into said chamber.

20. The method of claim 1, wherein said high pressure gas is delivered into said chamber at about 0 degrees Fahrenheit to about 200 degrees Fahrenheit.

21. The method of claim 1, further comprising the steps of:
monitoring the level of liquid cryogen in the bulk storage tank; and
using an automated system to order a refill for the bulk storage tank when said the cryogen decreases to a predetermined level.

22. The method of claim 1, further comprising the step of using a control means between said vessels and/or said tank, wherein said control means is selected from the group consisting essentially of a valve, a regulator, a pressure control valve, a safety valve, a solenoid valve, an isolation valve, an equalization valve, a rupture disc safety relief, and a combination thereof.

23. The method of claim 1, wherein a Trifecta™ unit is used to produce said pressurized liquid cryogen.

24. A method of producing of high pressure gas for quenching applications from cryogenic nitrogen liquid that is pressurized without the need of a pump or compressor, comprising:
obtaining cryogenic liquid comprising nitrogen;
storing the cryogenic liquid in a low pressure bulk storage tank at pressures less than or about 250 psig;
introducing the stored cryogenic liquid into a use vessel, leaving a portion of head space above said liquid;
increasing the pressure of said cryogenic liquid in said use vessel by using a pressure building apparatus that does not need a pump or compressor by vaporizing a portion of cryogenic liquid into gas and sending at least a portion of said gas into a head portion of said use vessel;
feeding pressurized liquid from the use vessel into a vaporizer that vaporizes said liquid into a high pressure gas of at least about 250 psig and up to about 500 psig;
delivering said gas into a chamber that contains heat treated metal at pressures greater than about 250 psig and flows of about 10,000 scfh or greater; and
at least partially quenching and cooling said heat treated metal with said gas.

25. The method of claim 24, further comprising the steps of:
monitoring the level of stored cryogenic liquid in said bulk storage tank; and
providing automated reordering of cryogenic liquid for said bulk storage tank.

26. The method of claim 24, wherein a Trifecta™ is used to pressurize said liquid.

27. The method of claim 24, further comprising the step of monitoring the dew point of the high pressure gas prior to delivering the gas to said chamber.

28. The method of claim 26, further comprising the step of storing the high pressure gas from said vaporizer in a buffer tank prior to delivering said high pressure gas to said chamber.

29. The method of claim 24, wherein said high pressure gas is delivered to said chamber continuously or periodically until said heat treated metal is at least partially cooled.

30. The method of claim 24, further comprising the step of monitoring and/or controlling the temperature of the gas prior to delivery into said chamber.

31. The method of claim 24, further comprising the step of monitoring the temperature of the chamber and/or metal during the quenching and cooling of said metal.

32. The method of claim 24, further comprising the step of providing an outlet in said chamber for the exit of gas that has become said heated gas.

33. A high pressure cryogenic gas quenching method for carburized and/or heat treated metal or metal alloys which comprises:
carburizing and/or heat treating metal in a heating chamber;
placing said carburized and/or heat metal in a quench chamber;
quenching said metal to a desired temperature and/or for a desired time with high pressure gas produced from pressurized cryogenic liquid, wherein said liquid is at least partially pressurized up to at least about 250 psig to about 450 psig without using a pump or compressor.

34. The method of claim 33, further comprising the steps of:
providing inert and/or partially inert cryogenic liquid;
storing inert and/or partially inert liquid at cryogenic temperatures in a bulk storage tank at pressures less than or about 250 psig;
feeding at least a portion of said liquid into a use vessel and/or a pressure building vessel;
increasing the pressure of said liquid in said use vessel to at least about 250 psig up to about 450 psig;
sending the pressurized liquid cryogen into a high pressure vaporizer;
vaporizing said pressurized liquid with a vaporizer to produce high pressure gas;
delivering said gas at pressures between about 250 psig and about 450 psig and flows from about 10,000 scfh to about 22,000 scfh into said quench chamber; and
at least partially cooling said heat treated metal with said high pressure gas.

35. The method of claim 34, wherein a Trifecta™ is used to pressurize said cryogenic liquid prior to vaporization.

36. The method of claim 35, wherein the vaporized gas is stored into a buffer tank before it is introduced into said quench chamber.

37. The method of claim 35, wherein the high pressure gas comprises at least one gas selected from the group that consists essentially of nitrogen, helium, argon, and/or a combination thereof.

38. The method of claim 35, wherein the cryogenic gas enters the quench chamber at about 0° C. to about 60° C.

39. The method of claim 35, wherein the gas is fed into the quench chamber at pressures of up to about 450 psig and flows of at least about 10,000 scfh.

40. A heated treated metal or metal alloy product manufactured by the method of claim 34.

41. A system for quenching heat treated metal without using oil to quench said parts, comprising:
inert and/or partially inert cryogenic liquid stored in a low pressure bulk storage tank at pressures less than or about 250 psig;
a use vessel that stores said cryogenic liquid at pressures at least about 250 psig to about 500 psig;
a means for increasing the pressure of cryogenic liquid to pressures of at least about 250 psig to about 500 psig, wherein said liquid is pressurized without the use of a pump or compressor;
a means for converting a portion of said pressurized cryogenic liquid into cryogenic gas;
a means for transferring at least a portion of said converted cryogenic gas into said use vessel;
a vaporizer that vaporizes said high pressure liquid into a high pressure gas of at least about 250 psig to about 500 psig;
a chamber that contains heat treated metal; and
wherein said high pressure gas is introduced into said chamber at pressures greater than about 250 psig and flows of about 10,000 scfh or greater, thereby at least partially quenching and cooling said heat treated metal.

42. The system of claim 41, wherein a pressure building apparatus is used as a means to increase the pressure of the cryogenic liquid.

43. The system of claim 42, wherein the pressure building apparatus is comprised of a Trifecta™ unit.

44. The system of claim 41, further comprising a dew point monitor that monitors the dew point of said high pressure gas prior to delivering said gas into the chamber.

45. The system of claim 41, further comprising at least one buffer tank for storing at least a portion of said high pressure gas prior to delivering said gas into said chamber.

46. The system of claim 45, further comprising a dew point monitor that monitors the dew point of said high pressure gas prior to storing said gas in said buffer tank.

47. The system of claim 41, wherein said high pressure gas comprises at least one gas selected from the group that consists essentially of nitrogen, argon, helium, or a combination thereof.

48. The system of claim 41, wherein said high pressure gas is delivered into said chamber at flows of at least about 10,000 scfh to about 22,000 scfh.

49. The system of claim 43, wherein a plurality of Trifecta™ units are used and wherein said units are configured in parallel and/or in series.

50. The system of claim 43, wherein said high pressure gas is delivered to said chamber periodically or continuously until said heat treated parts are at least partially cooled.

51. The system of claim 43, further comprising a means for monitoring the temperature of the gas prior to delivery into said chamber.

52. The system of claim 43, further comprising a means for monitoring the temperature of the chamber and/or heat treated metal during the quenching and cooling of said parts.

53. The system of claim 43, further comprising an outlet in said chamber for the exit of gas that has become heated.

54. The system of claim 43, further comprising a means for circulating the gas in said chamber.

55. The system of claim 43, further comprising a means for capturing and recycling at least a portion of said quench gas used in said chamber.

56. The system of claim 43, wherein said high pressure gas is delivered into said chamber at about 40 degrees Fahrenheit to about 200 degrees Fahrenheit.

57. The system of claim 43, further comprising a means for monitoring the level of liquid cryogen in the bulk storage tank; and
an automated system that orders a refill for the bulk storage tank when said the liquid cryogen decreases to a predetermined level.

58. The system of claim 43, further comprising at least one control means wherein said control means is selected from the group consisting essentially of a valve, a regulator, a pressure control valve, a safety valve, a solenoid valve, an isolation valve, an equalization valve, a rupture disc safety relief, and a combination thereof.

59. The system of claim 41, wherein said use vessel comprises a jacket and an inner tank and wherein an internal pressure builder communicates with said inner tank, whereby cryogenic liquid from said inner tank flows into said internal pressure builder that heats said liquid and produces said gas.

60. The system of claim 43, wherein the means for increasing the pressure of the cryogenic liquid comprises an external pressure building heat exchanger in communication with said internal pressure builder and the head space of the use vessel wherein heat from the internal pressure builder causes liquid to flow to said heat exchanger where said fluid is heated and produces gas; and
wherein said produced gas is delivered to the head space of said use vessel, thereby pressurizing said vessel.

61. The system of claim 41, wherein the means for increasing the pressure of the cryogenic liquid comprises a pressure building tank that contains a supply of cryogenic liquid, said pressure tank selectively communicating with said use vessel to pressurize said use vessel; and
wherein a heat exchange means is placed in circuit between the use vessel and the pressure building tank to selectively vaporize a portion of the cryogenic liquid from the use vessel into gas to recharge and maintain the pressure in said pressure building tank.

62. The system of claim 41, wherein the use vessel comprises a first use vessel and a second use vessel and wherein means at least temporarily connects the first use vessel and the second use vessel.
